(19) United States
(12) Patent Application Publication
(10) Pub. No.: US 2022/0097553 A1
(43) Pub. Date: Mar. 31, 2022

(54) CHARGING CONTROL METHOD, SERVER, AND SYSTEM

(71) Applicant: TOYOTA JIDOSHA KABUSHIKI KAISHA, Toyota-shi (JP)

(72) Inventors: Hiroshi HIGASHIDE, Nagoya-shi (JP); Keiichi UNO, Chita-gun (JP)

(73) Assignee: TOYOTA JIDOSHA KABUSHIKI KAISHA, Toyota-shi (JP)

(21) Appl. No.: 17/474,134

(22) Filed: Sep. 14, 2021

(30) Foreign Application Priority Data
Sep. 30, 2020 (JP) 2020-166540

(51) Int. Cl. B60L 53/68; B60L 53/67; B60L 53/30

(52) U.S. Cl. CPC B60L 53/68; B60L 53/67; B60L 2240/662; B60L 2200/18; B60L 53/305

(57) ABSTRACT

A charging control method of the present disclosure is a charging control method for controlling charging of a battery of each vehicle in a plurality of vehicles, each vehicle traveling along a predetermined route in accordance with an operation schedule and then sequentially switching with another vehicle and charging the battery for subsequent travel. The charging control method includes measuring an environmental temperature at which charging is to be performed, determining a first state of charge, at which charging is to end, based on the measured environmental temperature, and charging the battery of the vehicle to be charged to the first state of charge. Furthermore, the first state of charge when the environmental temperature is a second temperature lower than a first temperature is determined to be lower than the first state of charge when the environmental temperature is the first temperature.

### CROSS-REFERENCE TO RELATED APPLICATION

This application claims priority to Japanese Patent Application No. 2020-166540, filed on Sep. 30, 2020, the entire contents of which are incorporated herein by reference.

### TECHNICAL FIELD

The present disclosure relates to a charging control method, a server, and a system for controlling the charging of a battery.

### BACKGROUND

In recent years, a vehicle operation management system that includes a plurality of electric vehicles, for transporting users by circulating along a predetermined route, and a server, for managing the plurality of electric vehicles, has been proposed. For example, patent literature (PTL) 1 discloses judging whether travel according to a scheduled operation plan is possible based on the maximum output value of a battery mounted on an electric vehicle circulating along a predetermined travel route, and as necessary, reconstructing the operation plan. The vehicle in PTL 1 can thereby provide the transportation service without delay when the maximum output value of the electric vehicle or the required output value of the electric vehicle fluctuates due to unexpected circumstances.

### CITATION LIST

### Patent Literature

PTL 1: JP 2020-013379 A

### SUMMARY

Conventional systems that manage vehicle operation do not take into account how the charging period differs depending on the temperature of the environment when the electric vehicle is charged. When the environmental temperature at which charging is performed is low, the vehicle usage efficiency may be reduced due to a longer time required to charge the battery to a predetermined state of charge. This may lead to the need for more vehicles when the environmental temperature at which charging is performed is low.

It would be helpful to provide a charging control method, a server, and a system that, even when the environmental temperature at which charging is performed is relatively low, can utilize an electric vehicle with a usage efficiency that is closer to the usage efficiency when the environmental temperature at which charging is performed is relatively high.

A charging control method according to an embodiment of the present disclosure is a charging control method for controlling charging of a battery of each vehicle in a plurality of vehicles, each vehicle traveling along a predetermined route in accordance with an operation schedule and then sequentially switching with another vehicle and charging the battery for subsequent travel. The charging control method includes measuring an environmental temperature at which charging is to be performed, determining a first state of charge, at which charging is to end, based on the measured environmental temperature, and charging the battery of the vehicle to be charged to the first state of charge. Furthermore, the first state of charge when the environmental temperature is a second temperature lower than a first temperature is determined to be lower than the first state of charge when the environmental temperature is the first temperature.

A server according to an embodiment of the present disclosure is a server for controlling charging of a battery of each vehicle in a plurality of vehicles, each vehicle traveling along a predetermined route in accordance with an operation schedule and then sequentially switching with another vehicle and charging the battery for subsequent travel. The server includes an acquisition interface configured to acquire an environmental temperature at which charging is to be performed, a controller configured to determine a first state of charge, at which charging is to end, based on the environmental temperature, and a communication interface configured to transmit, to a charging apparatus, an instruction to charge the battery of the vehicle to be charged to the first state of charge. The controller is configured to determine the first state of charge when the environmental temperature is a second temperature lower than a first temperature to be lower than the first state of charge when the environmental temperature is the first temperature.

A system according to an embodiment of the present disclosure is a system for controlling charging of a battery of each vehicle in a plurality of vehicles, each vehicle traveling along a predetermined route in accordance with an operation schedule and then sequentially switching with another vehicle and charging the battery for subsequent travel. The system includes a plurality of vehicles, a temperature sensor configured to measure an environmental temperature at which charging is to be performed, a server comprising a controller configured to determine a first state of charge, at which charging is to end, based on the environmental temperature, and a charging apparatus configured to charge the battery of the vehicle to be charged to the first state of charge. The controller is configured to determine the first state of charge when the environmental temperature is a second temperature lower than a first temperature to be lower than the first state of charge when the environmental temperature is the first temperature.

According to the present disclosure, the usage efficiency of a vehicle when the environmental temperature at which charging is performed is relatively low can be brought closer to the usage efficiency of a vehicle when the environmental temperature at which charging is performed is relatively high.

### BRIEF DESCRIPTION OF THE DRAWINGS

In the accompanying drawings:

FIG. 1 is a diagram illustrating a schematic configuration of a charging control system according to an embodiment of the present disclosure;

FIG. 2 is a block diagram illustrating a schematic configuration of a vehicle of FIG. 1;

FIG. 3 is a diagram illustrating an example travel route of a vehicle;

FIG. 4 is a diagram illustrating an example travel schedule of a vehicle;

FIG. 5 is a diagram illustrating an example of a change in the state of charge with respect to elapsed time when the battery is charged from a state of charge of 0%;

FIG. 6 is a diagram illustrating an example of a change in the state of charge with respect to elapsed time when the environmental temperature at which charging is performed is lower than in the example of FIG. 5;

FIG. 7 is a diagram illustrating a charging method in the case of FIG. 6;

FIG. 8 is a flowchart illustrating a vehicle battery charging method according to an embodiment of the present disclosure; and

FIG. 9 is a flowchart illustrating a method of determining the first state of charge of FIG. 8.

### DETAILED DESCRIPTION

Embodiments of the present disclosure are described below with reference to the drawings. The drawings referred to below are schematic. The dimensional ratios and the like in the drawings do not necessarily match actual ratios.

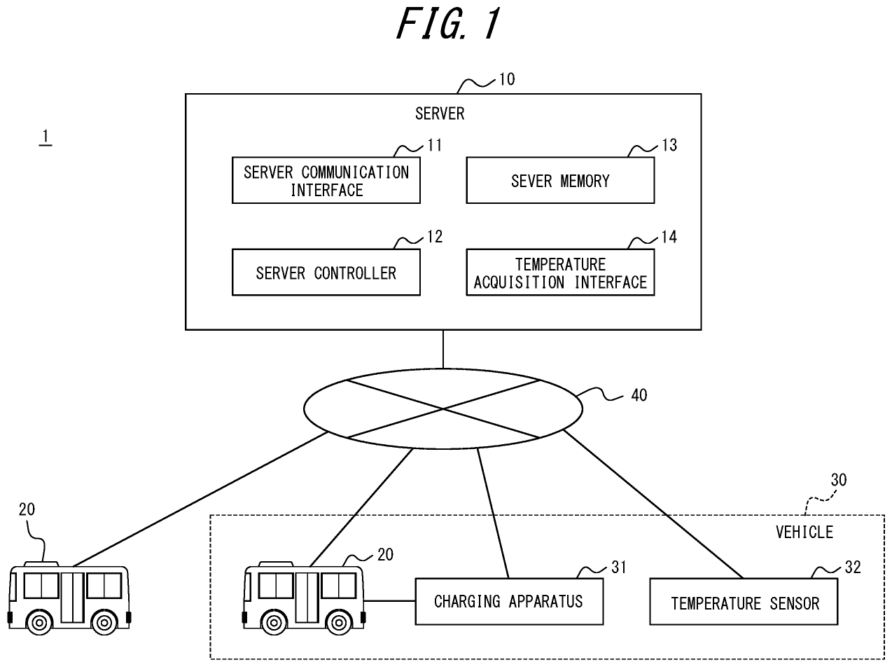

FIG. 1 is a block diagram illustrating a schematic configuration of a charging control system 1 according to an embodiment of the present disclosure. The charging control system 1 includes a server 10, a plurality of vehicles 20, and a charging apparatus 31 and temperature sensor 32 disposed in a garage 30. The server 10 may be located in the same location as the facility in which the garage 30 is located or may be located in a different facility from the facility in which the garage 30 is located. The server 10, the charging apparatus 31, and the temperature sensor 32 can transmit and receive information. The server 10, the charging apparatus 31, and the temperature sensor 32 may be connected individually by communication lines or may be connected via a network 40. The server 10 and the plurality of vehicles 20 may be connected to the network 40 and configured to communicate with each other.

(Server Configuration)

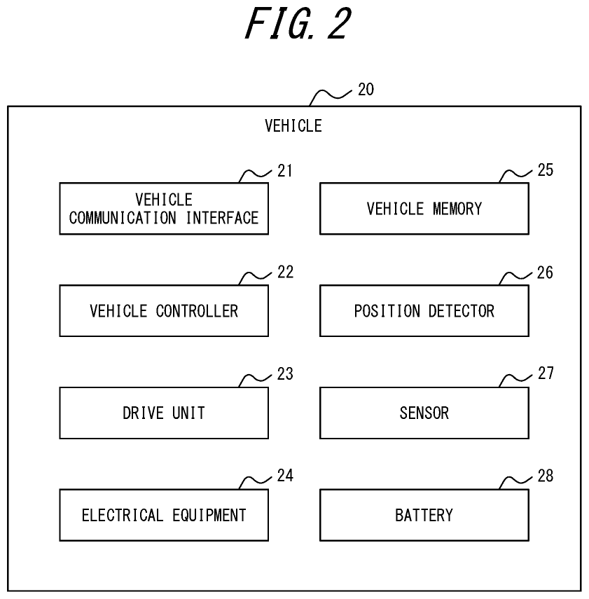

The server 10 controls charging of batteries 28 (see FIG. 2) of the plurality of vehicles 20. The server 10 may manage the operation of the plurality of vehicles 20. Alternatively, the server 10 may be configured to communicate with another server that manages the operation of the plurality of vehicles 20. The server 10 includes a server communication interface 11 (communication interface), a server controller 12 (controller), a server memory 13, and a temperature acquisition interface 14 (acquisition interface).

The server communication interface 11 includes a communication module and is configured to transmit and receive of information to and from the vehicles 20 and the charging apparatus 31. The server communication interface 11 can perform processing such as protocol processing related to transmitting and receiving information, modulation of the transmitted signal and demodulation of the received signal, and the like.

The server controller 12 controls the components included in the server 10. The server controller 12 can acquire a variety of information including the state of charge (SOC) of the battery 28 from the vehicle 20 via the server communication interface 11. The server controller 12 can acquire the temperature information on the surrounding environment when the battery 28 is charged from the temperature sensor 32 via the temperature acquisition interface 14. The temperature of the surrounding environment when the battery 28 is charged is referred to below as the “environmental temperature”. The server controller 12 can control the charging apparatus 31 via the server communication interface 11. The server controller 12 can control the start and end of charging of the battery 28 by the charging apparatus 31. The server controller 12 can transmit an instruction to the charging apparatus 31 to charge the battery 28 of the vehicle 20 to a predetermined state of charge. Here, the state of charge is the ratio of the remaining capacity to the capacity of the fully charged battery, expressed as a percentage (%). The state of charge can be referred to as the remaining battery capacity or remaining capacity.

The server controller 12 may include one or more processors. The server controller 12 may include a variety of processors. Processors include general purpose processors that execute programmed functions by loading specific programs and dedicated processors that are specific to specific processes. A digital signal processor (DSP), an application specific integrated circuit (ASIC), a field-programmable gate array (FPGA), and the like can be used as a dedicated processor.

The server memory 13 stores programs executed by the server controller 12 and information required for processing executed by the server controller 12. The server memory 13 may include a semiconductor memory, a magnetic storage device, and an optical storage device. Semiconductor memory includes read only memory (ROM), random access memory (RAM), flash memory, and the like. RAM can include dynamic random access memory (DRAM) and static random access memory (SRAM). Magnetic storage devices include a hard disk and the like. Optical storage devices include, for example, compact discs (CDs), digital versatile discs (DVDs), and Blu-ray® (Blu-ray is a registered trademark in Japan, other countries, or both).

The temperature acquisition interface 14 is configured to acquire information on the environmental temperature for charging the vehicle 20 from the temperature sensor 32 of the garage 30. The temperature acquisition interface 14 may acquire the information on the environmental temperature via the network 40. The temperature acquisition interface 14 may acquire information on the environmental temperature using a different communication path than the network 40. The temperature acquisition interface 14 may be configured in part or in whole using the same components as the server communication interface 11. Instead of using the temperature sensor 32 disposed in the garage 30, the charging control system 1 can measure the environmental temperature for charging by using a temperature sensor, included in each vehicle 20, for measuring the outside temperature. In this case, the temperature acquisition interface 14 may acquire information on the environmental temperature from the vehicle 20 via the network 40.

(Vehicle Configuration)

The vehicle 20 is a self-driving vehicle that travels along a predetermined route according to an operation schedule. The vehicle 20 is a form of vehicle such as a bus for passenger transport. The vehicle 20 may allow users to get on and off at stops located along the travel route. After traveling along predetermined routes in accordance with the operation schedule, the vehicle 20 sequentially switches with another vehicle 20 and charges the battery for subsequent travel. Autonomous driving of the vehicle 20 may be implemented at any level from Level 1 to Level 5 as defined, for example, by the Society of Automotive Engineers (SAE). The autonomous driving is not limited to the exemplified definition and may be implemented based on other definitions. An electric automobile that runs using electric power is used as the vehicle 20.

As illustrated in FIG. 2, the vehicle 20 includes a vehicle communication interface 21, a vehicle controller 22, a drive unit 23, electrical equipment 24, a vehicle memory 25, a position detector 26, a sensor 27, and a battery 28. The components of the vehicle 20 are, for example, communicably connected to each other via a vehicle-mounted network, such as a controller area network (CAN), or a dedicated line.

The vehicle communication interface 21 is configured to transmit and receive information to and from the server 10 via the network 40. The vehicle communication interface 21 may, for example, be a vehicle-mounted communication device. The vehicle communication interface 21 may include a communication module that connects to the network 40. The communication module may include a communication module compliant with mobile communication standards such as 4th Generation (4G) and 5th Generation (5G).

The vehicle controller 22 controls the components included in the vehicle 20. The vehicle controller 22 may include one or more processors. The vehicle controller 22 may include various processors, like the server controller 12. The vehicle controller 22 controls the drive unit 23 to travel over a predetermined route by autonomous driving in accordance with an operation schedule. The vehicle controller 22 may acquire information on the state of charge from the battery 28 and transmit the information to the server 10.

The drive unit 23 provides functions relating to travel of the vehicle 20. Under the control of the vehicle controller 22, the drive unit 23 causes the vehicle 20 to travel. The drive unit 23 includes a motor, steering, brakes, and the like. The drive unit 23 may cause the vehicle 20 to travel by autonomous driving under the control of the vehicle controller 22 and in cooperation with the position detector 26 and the sensor 27.

The electrical equipment 24 includes various types of equipment that consumes electric power within the vehicle 20 other than the drive unit 23. The electrical equipment 24 includes an air conditioner, headlights, automatic doors, display apparatuses, and the like within the vehicle 20.

The vehicle memory 25 stores programs executed by the vehicle controller 22 and information required for processing executed by the vehicle controller 22. Like the server memory 13, the vehicle memory 25 may include a semiconductor memory, a magnetic storage device, and an optical storage device. The vehicle memory 25 may store a travel route and an operation schedule on which the vehicle 20 travels.

The position detector 26 acquires positional information for the vehicle 20. The position detector 26 may include a receiver compliant with the Global Navigation Satellite System (GNSS). Receivers compliant with the GNSS may, for example, include a Global Positioning System (GPS) receiver. In the present embodiment, the vehicle 20 is assumed to be capable of acquiring positional information for the vehicle 20 itself using the position detector 26. The vehicle 20 may transmit the positional information for the vehicle 20 itself to the server 10 via the vehicle communication interface 21.

The sensor 27 is a sensor used in autonomous driving to detect the outside of the vehicle 20. The sensor 27 can detect people and objects around the vehicle 20. The sensor 27 includes a sensor that measures the distance to the vehicle ahead when traveling. Light detection and ranging (LIDAR), millimeter wave radar, ultrasonic sensors, and cameras, for example, are included in the sensor 27. Cameras include a stereo camera in which a plurality of cameras are arranged facing the same direction. The sensor 27 may also include a temperature sensor that measures the outside air temperature of the vehicle 20.

The battery 28 is a secondary cell that can be repeatedly charged and discharged. The battery 28 supplies power to at least the drive unit 23 of the vehicle 20. The battery 28 may supply power to all apparatuses that require power, including the electrical equipment 24 of the vehicle 20. The vehicle 20 can include other batteries in addition to the battery 28. Any secondary cell can be used for the battery 28. The battery 28 can, for example, be a lithium ion battery, a nickel metal hydride battery, a sodium ion battery, a magnesium air battery, a lithium air battery, or a zinc air battery.

The vehicle controller 22 can acquire or estimate the state of charge of the battery 28 of each vehicle 20. For example, the vehicle memory 25 stores, in advance, SOC-OCV characteristics indicating the relationship between the open circuit voltage (OCV) between terminals of the battery 28 and the state of charge (SOC). The vehicle controller 22 acquires the voltage between the terminals of the battery 28 from the battery 28 and estimates the open circuit voltage. The vehicle controller 22 can estimate the state of charge based on the estimated open circuit voltage and the SOC-OCV characteristics stored in the vehicle memory 25. The battery 28 may, for example, also calculate the state of charge by a current integration method. In this case, the battery 28 can include a mechanism for calculating the integrated value yielded by integrating the current during charging and discharging over time. The vehicle controller 22 can thus acquire the amount of charge accumulated in the battery 28 and calculate the state of charge. The vehicle controller 22 may use a plurality of means in combination to estimate the state of charge of the battery 28.

The battery 28 can be charged by a charging base, such as the garage 30 of FIG. 1, or the charging apparatus 31 installed in a vehicle base. The charging apparatus 31 charges the battery 28 of the vehicle 20 in a wired or wireless manner. In a wired power supply system, the charging apparatus 31 and the vehicle 20 are connected by a cable and a connector for charging. In a wireless power supply method, power is supplied by a magnetic field coupling method, a magnetic field resonance method, or the like from a power transmission coil of the charging apparatus 31 to a power receiving coil of the vehicle 20.

In an embodiment, the charging apparatus 31 charges the battery 28 under the control of the server controller 12 of the server 10. The server controller 12 controls the start and end of power supply to the battery 28. The server 10 may acquire the state of charge of the battery 28 during charging from the vehicle 20 via the network 40. The server 10 may acquire the state of charge of the battery 28 during charging via the charging apparatus 31.

(Vehicle Operation)

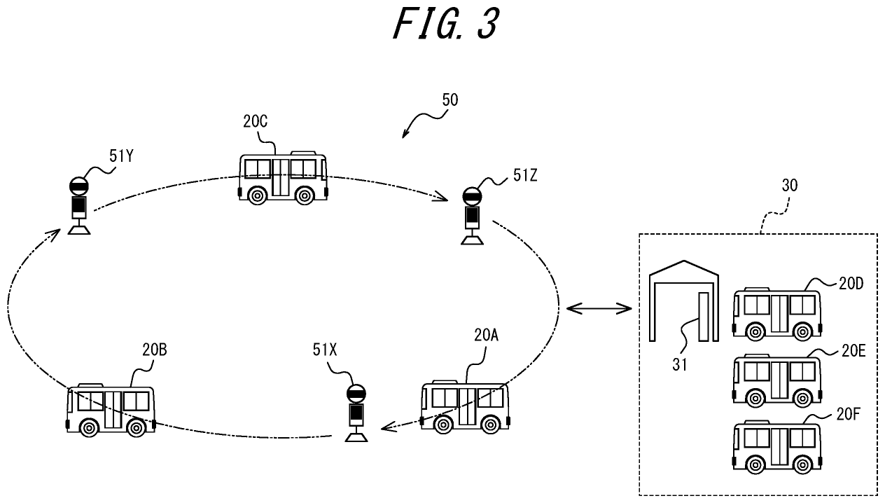

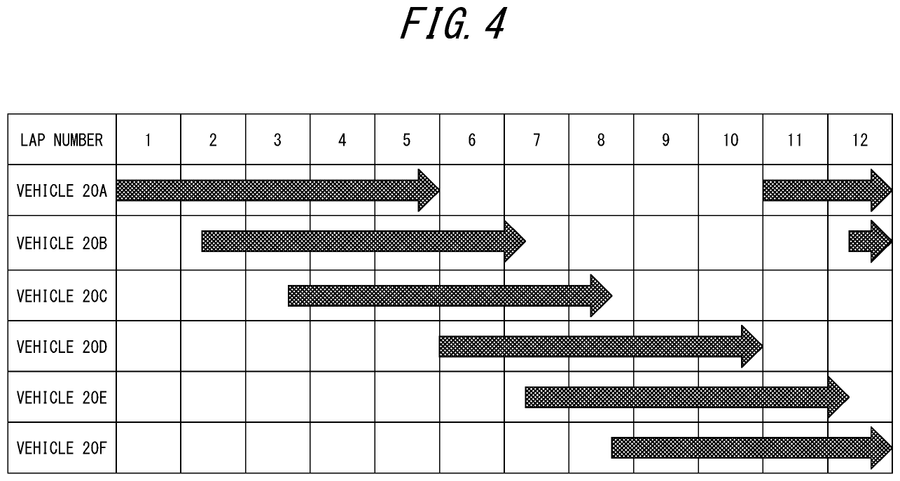

An example of operation of a plurality of vehicles 20 is described with reference to FIGS. 3 and 4. In FIG. 3, the plurality of vehicles 20 includes vehicles 20A, 20B, 20C, 20D, 20E, and 20F. Each vehicle 20 travels along a predetermined travel route 50 in accordance with an operation schedule. The travel route 50 includes a route that traverses a circular route, a route that goes back and forth over a linear route, and the like. In FIG. 3, the travel route 50 is a circular route. In the travel route 50, a plurality of stops 51X, 51Y, 51Z are provided for the user to get on and off. The vehicle 20 returns to the stop 51X after sequentially stopping at the stops 51X, 51Y, 51Z. Each vehicle 20 travels to the garage 30 after a predetermined number of laps around the travel route 50 (a predetermined number of round trips in the case of a linear route) in accordance with the operation schedule. Upon entering the garage 30, predetermined maintenance operations are performed on the vehicle 20, and the battery 28 is charged by the charging apparatus 31. The charging of the battery 28 may follow pre-programmed procedures and be fully automatic. The charging of the battery 28 may be at least partially performed by human intervention.

As schematically illustrated in FIG. 4, the vehicles 20 are, for example, dispatched so that at each point in time there are three vehicles 20 traveling along the travel route 50. According to the example in FIG. 4, first, the vehicle 20A is introduced into the travel route 50, and after the vehicle 20A circulates through the travel route 50 once, the vehicle 20B is introduced into the travel route 50. The vehicle 20B may be introduced so as to travel behind the vehicle 20A at a distance corresponding to approximately one-third of the travel route 50. The vehicle 20B is then introduced into the travel route 50, and after the vehicle 20B circulates through the travel route 50 once, the vehicle 20C is further introduced into the travel route 50. The vehicle 20C may be introduced so as to travel behind the vehicle 20B at a distance corresponding to approximately one-third of the travel route 50. In the example in FIG. 4, the vehicle 20A, the vehicle 20B, and the vehicle 20C each make five laps around the travel route 50.

On the fifth lap around the travel route 50, the vehicle 20A displays, on the inside and outside of the vehicle 20A, that the stop 51X at the end of the fifth lap will be the final stop. Upon arriving at the stop 51X, the vehicle 20A lets all users off, exits the travel route 50, and travels to the garage 30. At the same timing as when the vehicle 20A exits the travel route 50, the vehicle 20D that was waiting in the garage 30 is introduced into the travel route 50 and begins to make laps around the travel route 50 starting from the stop 51X. Like the vehicle 20A, the vehicle 20B and the vehicle 20C also exit the travel route 50 and move to the garage 30 after the fifth lap around the travel route 50. The vehicle 20E and the vehicle 20F are respectively introduced into the travel route 50 at the same timing as when the vehicle 20B and the vehicle 20C exit the travel route 50.

Each vehicle 20 consumes power while circulating along the travel route 50, and the state of charge of the battery 28 reduces. Each vehicle 20 charges the battery 28 according to a predetermined schedule while waiting in the garage 30. The vehicles 20 for which charging has ended are introduced into the travel route 50 at a later, predetermined timing and transport users. For example, the vehicle 20A is charged within a period corresponding to the 6^{th} to 10^{th} lap from the start of travel and is introduced into the travel route 50 again at a timing corresponding to the 11^{th} lap from the start of travel.

In this way, in the example illustrated in FIGS. 3 and 4, the six vehicles 20A-20F enable three vehicles to continually transport users along the travel route 50. Also, the vehicles 20 can be made to continually circulate along the travel route 50 at uniform time intervals.

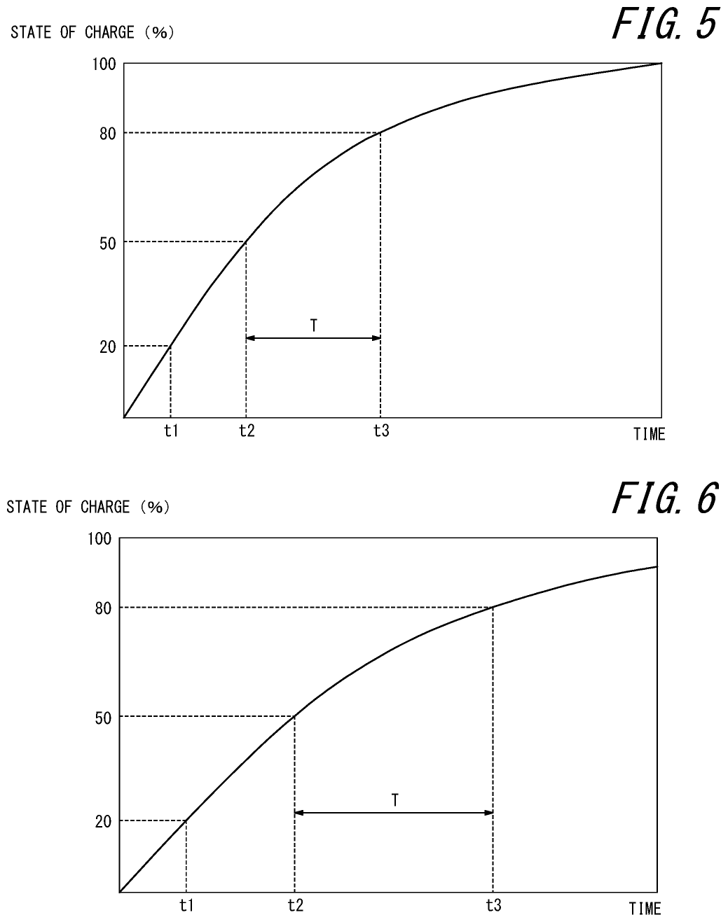

FIG. 5 is a diagram illustrating an example of a change in the state of charge with respect to elapsed time when the battery 28 is charged from a state of charge of 0% at a first temperature. The first temperature can, for example, be 25° C. FIG. 5 illustrates an example of the charging characteristics of the battery 28. According to FIG. 5, a period of t2−t1 is required to charge the battery 28 from a state of charge of 20% to 50%. A period of t3−t2 is required to charge the battery 28 from a state of charge of 50% to 80%. For example, if the vehicle 20 travels according to the operation schedule and uses 30% of the electrical charge stored in the battery 28 at a state of charge of 100%, then the server controller 12 can use the area for the state of charge of 50%-80% of the battery 28. In FIG. 5, the charging period required for this charging is represented as T.

However, it may not be possible to maintain a constant environmental temperature at which the charging apparatus 31 charges the battery 28. It is known that when the environmental temperature at the time of charging is relatively low, the charging rate is slower than when the temperature is high. Therefore, for a constant charging period T, the capacity that can be charged is smaller when the environmental temperature is low than when the temperature is high. Consequently, it may be impossible to travel the entire route determined in advance by the operation schedule. Alternatively, if the environmental temperature is low, attempting to charge to the same state of charge as when the environmental temperature is high requires a longer charging period T than for a high environmental temperature. Consequently, a lower environmental temperature may require that the vehicle 20 wait for a relatively long time in the garage. More vehicles 20 may therefore be necessary at low environmental temperatures than at high environmental temperatures.

For example, suppose that the environmental temperature for charging the battery 28 becomes a second temperature lower than the first temperature, and the charging characteristics of the battery 28 change as illustrated in FIGS. 5 and 6. The second temperature is, for example, 5° C. In this case, the charging period T (equal to t3−t2) required to charge the battery 28 from a state of charge of 50% to 80% is longer than in FIG. 5. For example, whereas the charging period T required for charging is 20 minutes in FIG. 5, the charging period T required for charging in FIG. 6 may become 30 minutes.

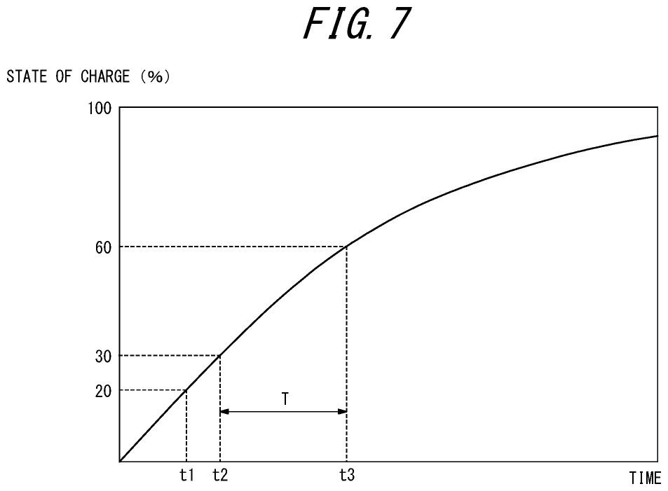

Therefore, in the charging control system 1 of the present embodiment, the state of charge at which charging is to end is determined as a first state of charge based on the environmental temperature at which the server controller 12 performs charging. For example, for the charging characteristics of FIG. 6, the first state of charge is set to 60% as illustrated in FIG. 7. If the amount of electricity (the amount of charge) discharged when traveling according to the operation schedule is 30% of the capacity when the state of charge is 100%, the state of charge of the vehicle 20 after traveling on the travel route 50 becomes 30%. This enables the battery 28 to be charged from a state of charge of 30% to a state of charge of 60% during a charge period T substantially equivalent to the case illustrated in FIG. 5. When the environmental temperature is a second temperature lower than the first temperature, the first state of charge is determined to be lower than the first state of charge in the case of the first temperature. As the state of charge is higher, the amount of electricity that can be charged per unit time reduces. The charging rate can therefore be increased by charging the battery 28 using a low state of charge region. However, taking into consideration the amount of electricity discharged during travel along the travel route 50, the first state of charge is preferably set to as high a value as possible to provide a margin in the amount of charge of the battery 28.

The server controller 12 may calculate the first state of charge from the temperature acquired from the temperature sensor 32 and the charging characteristics of the battery 28. Alternatively, the server controller 12 may determine the first state of charge as a function of the environmental temperature. The first state of charge is a function that monotonically increases with respect to the environmental temperature at which charging is performed. Alternatively, the server 10 can store a table associating the environmental temperature and the first state of charge in the server memory 13. The server controller 12 may refer to this table to determine the first state of charge.

The time that the vehicle 20 can charge in the garage 30 is limited by the time from when the vehicle 20 exits the travel route 50 until the vehicle 20 is next introduced to the travel route 50, the time for maintenance, the number of available charging apparatuses 31, and the like. Also, the state of charge before charging of the vehicle 20 may vary depending on various conditions, such as traffic along the travel route 50 or the number of users. Below, the state of charge before charging of the vehicle 20 is referred to as the second state of charge. The server controller 12 may judge whether the battery 28 at the second state of charge can be charged to the first state of charge within a predetermined time until subsequent travel. When it is judged that the battery 28 cannot be charged to the first state of charge within the predetermined time, the server controller 12 may reset the first state of charge in a range enabling charging within the predetermined time.

The amount of electricity predicted to be discharged by travel along the travel route 50 in accordance with the operation schedule when the battery 28 is at the first state of charge is designated the predicted discharge amount. The server controller 12 performs control so that the state of charge after discharge of the predicted discharge amount exceeds a third state of charge that is the lowest allowable state of charge for the battery 28. The third state of charge is the lowest voltage set so that the battery 28 can be discharged in a range allowing safe use. The third state of charge is determined by the type, structure, and the like of the battery. The third state of charge can, for example, be set to 20%.

The server controller 12 can set the predicted discharge amount while taking into consideration the length of the travel route 50 along which the vehicle 20 travels. The longer the travel route 50 is, the greater the predicted discharge amount becomes as compared to when the travel route 50 is short. The vehicle controller 22 may set the predicted discharge amount while taking into consideration the undulation of the travel route 50, the number of intersections, and the like.

The server controller 12 can set the predicted discharge amount while taking into consideration meteorological conditions of the travel route 50 along which the vehicle 20 travels. The vehicle controller 22 may be configured to acquire meteorological information from an external source of information or from the vehicle 20 in operation. The power required to drive the vehicle 20 may change due to conditions such as wind, rain, or temperature. For example, when the road surface is wet in bad weather, the predicted discharge amount may be set larger than when the weather is not bad, since the rolling resistance of the tires increases. When the air temperature outside the vehicle is high, for example, the predicted discharge amount may be set larger than when the air temperature is low, out of consideration for the power consumed by the air conditioner. Furthermore, unexpected delays may occur in the operation schedule during bad weather, for example. If a delay occurs in the operation schedule, the power consumed within the vehicle 20 may increase. Consequently, the server controller 12 may set the predicted discharge amount to a larger value during bad weather as a precaution.

The server controller 12 can set the predicted discharge amount while taking into consideration congestion of the travel route 50 along which the vehicle 20 travels. The server controller 12 may be configured to acquire congestion information from an external source of information or from the vehicle 20 in operation. When a congested road is included in the travel route 50, the amount of power consumption per travel distance increases, and the travel time also increases. Accordingly, the predicted discharge amount may be set larger than when the travel route 50 is not congested. It is also difficult to estimate the discharge amount accurately when travel route 50 is congested. The server controller 12 may therefore set the predicted discharge amount to a larger value out of consideration for deviation from the prediction.

The server controller 12 can set the predicted discharge amount while taking into consideration the estimated number of users on board the vehicle 20. The server controller 12 may be configured to acquire congestion information from an external source of information or from the vehicle 20 in operation. For example, the server controller 12 may acquire event information around the travel route 50 from an external information source in advance and estimate the number of users based on this information. The server controller 12 may also estimate the current number of users based on past information on users of the vehicle 20 for each day of the week and time period. The past information on users of the vehicle 20 can be accumulated in the server memory 13. The server controller 12 may set a larger predicted discharge amount for the vehicle 20 when the number of users is estimated to be greater.

The server controller 12 determines a first state of charge so that the state of charge after travel in accordance with the operation schedule and discharge of the predicted discharge amount of electricity is higher than the third state of charge. The server controller 12 changes the operation schedule of the plurality of vehicles 20 when the state of charge of the battery 28 is estimated to fall below the third state of charge upon the predicted discharge amount of electricity being discharged from the battery 28 at the first state of charge determined based on the environmental temperature. For example, the server controller 12 may reduce the number of laps the vehicle 20 makes around the travel route 50. If another vehicle 20 is available, the server controller 12 may cause the traveling vehicle 20 to switch. The server 10 may transmit the modified operation schedule to each vehicle 20.

(Charging Control Method)

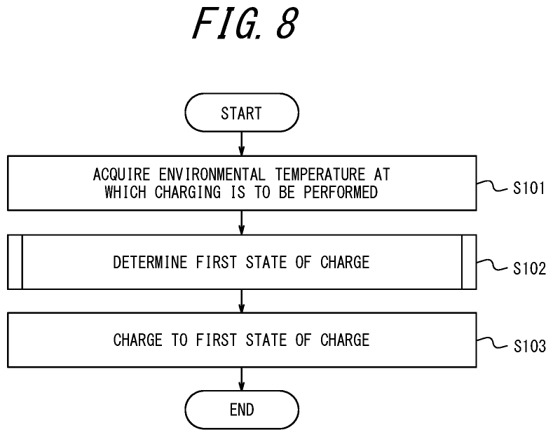

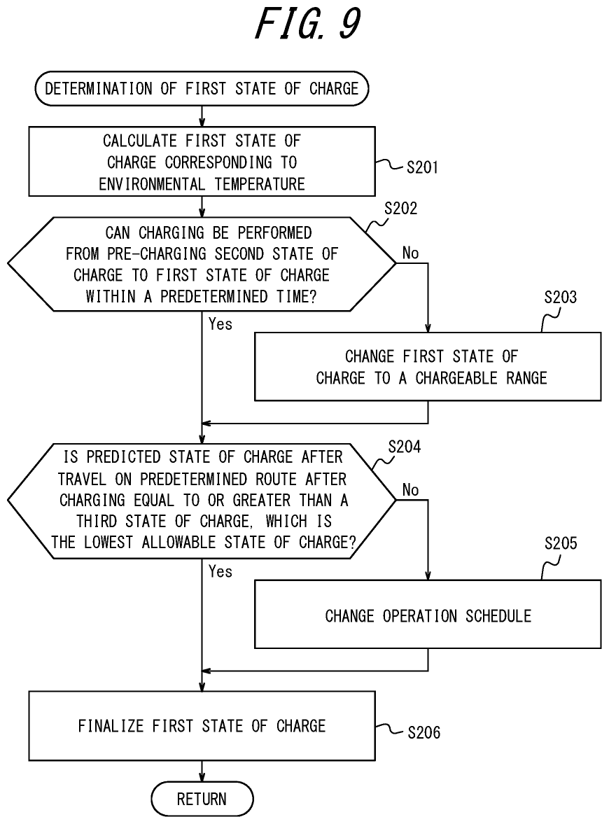

A charging control method executed by the server controller 12 is now described with reference to FIGS. 8 and 9.

The server controller 12 acquires the environmental temperature at which to charge the vehicle 20 (step S101). In the example illustrated in FIG. 1, the server controller 12 acquires the temperature detected by the temperature sensor 32 in the garage 30 via the network 40. The server controller 12 may acquire a signal, from the vehicle 20 or the charging apparatus 31, indicating that the vehicle 20 can be charged by the charging apparatus 31 and may execute the process of step S101 using this signal as a trigger.

Next, based on the acquired temperature, the server controller 12 determines the first state of charge of the vehicle 20 (step S102).

Details of the procedure for determining the first state of charge in step S102 are illustrated in FIG. 9.

The server controller 12 derives the first state of charge based on the environmental temperature, acquired in step S101, at which charging is to be performed (step S201). The first state of charge may be determined based on the charging characteristics of the battery 28.

The server controller 12 judges whether charging from the pre-charging second state of charge to the first state of charge can be performed within the time allocated for charging of the vehicle 20 (step S202). When charging to the first state of charge can be performed (step S202: Yes), the processing by the server controller 12 advances to step S204. When charging to the first state of charge cannot be performed (step S202: No), the server controller 12 changes the first state of charge to a state of charge within a chargeable range (step S203) and advances to step S204.

The server controller 12 judges whether the predicted state of charge after travel on a predetermined route after charging is equal to or greater than the third state of charge, which is the lowest allowable state of charge (step S204). When the predicted state of charge after travel on the predetermined route is equal to or higher than the third state of charge (step S204: Yes), the processing of the server controller 12 advances to step S206. When the predicted state of charge after travel on the predetermined route is less than the third state of charge (step S204: No), the server controller 12 changes the operation schedule so that the state of charge does not fall below the third state of charge while the vehicle 20 is traveling on the travel route 50 (step S205). After completion of step S205, the processing of the server controller 12 advances to step S206.

The server controller 12 finalizes the first state of charge (step S206) and returns to the flowchart of FIG. 8.

The server controller 12 controls the charging apparatus 31 to perform charging to the first state of charge finalized in step S206 (step S103). The server controller 12 may control the charging apparatus 31 while acquiring information on the state of charge of the battery 28 at each point in time during charging from the vehicle 20.

According to the charging control system 1, the server 10, and the charging control method of the present disclosure, the first state of charge when the environmental temperature at which charging is to be performed is a first temperature is determined to be lower than the first state of charge when the environmental temperature is a second temperature higher than the first temperature. Therefore, even in the case of the first temperature, at which the environmental temperature is relatively low, charging can be performed within a predetermined time to an amount of electrical charge closer to the case of the second temperature, at which the environmental temperature is relatively high. This allows the vehicle 20 to be used with a usage efficiency closer to the case of the second temperature.

The first state of charge is determined to be a higher state of charge than the third state of charge, which is the lowest allowable state of charge for the battery, after the battery 28 discharges the predicted discharge amount of electricity from the first state of charge, the predicted discharge amount being predicted to be discharged by travel over the predetermined route. When the environmental temperature in which charging is to be performed is low, the first state of charge can thus be set low while ensuring that the state of charge does not fall below the third state of charge during travel. Problems due to a decrease in the state of charge during travel, a dead battery, or the like can therefore be prevented.

In the above embodiment, the battery 28 of the vehicle 20 is assumed to be charged while attached to the vehicle 20. The battery 28 may, however, be configured to be removable from the vehicle 20. In this case, the battery 28 is assumed to chargeable while separated from the vehicle 20. After the vehicle 20 travels along the travel route 50 according to the travel schedule, the battery of the vehicle 20 can be replaced by a charged battery in the garage 30. Even in this case, the charging method of the present disclosure can be applied to each battery 28. When the number of batteries 28 is limited, and the environmental temperature at which charging is to be performed is low, the charging method of the present disclosure can bring the usage efficiency of the batteries 28 closer to the case of a high environmental temperature at which charging is to be performed.

In the above embodiment, the server controller 12 of the server 10 controls the start and end of charging of each vehicle 20. However, the vehicle controller 22 of the vehicle 20 may include at least some of the functions of the server controller 12 of the above-described embodiment. For example, the vehicle controller 22 may be configured to acquire information on the environmental temperature from the charging apparatus 31 connected for charging and to control the charging apparatus 31. The vehicle controller 22 may determine the first state of charge based on the environmental temperature. The vehicle controller 22 may control the end of charging based on the determined first state of charge. The charging control method of the present disclosure can thus also be performed by the vehicle 20 and the charging apparatus 31.

While embodiments of the present disclosure have been described based on the drawings and examples, it should be noted that various changes and modifications may be made by those skilled in the art based on the present disclosure. Accordingly, such changes and modifications are included within the scope of the present disclosure. For example, the functions and the like included in each component, step, or the like can be rearranged in a logically consistent manner. Components, steps, or the like may also be combined into one or divided. Although embodiments of the present disclosure have been described focusing on apparatuses, an embodiment of the present disclosure may also be implemented as a method including the steps performed by each component of the apparatuses. An embodiment of the present disclosure may also be implemented as a method or program executed by a processor provided in an apparatus or as a storage medium with the program recorded thereon. It is to be understood that these embodiments are also included within the scope of the present disclosure.

1. A charging control method for controlling charging of a battery of each vehicle in a plurality of vehicles, each vehicle traveling along a predetermined route in accordance with an operation schedule and then sequentially switching with another vehicle and charging the battery for subsequent travel, the charging control method comprising:
measuring an environmental temperature at which charging is to be performed;
determining a first state of charge, at which charging is to end, based on the measured environmental temperature; and
charging the battery of the vehicle to be charged to the first state of charge; wherein
the first state of charge when the environmental temperature is a second temperature lower than a first temperature is determined to be lower than the first state of charge when the environmental temperature is the first temperature.

2. The charging control method of claim 1, wherein the first state of charge is determined as a function of the environmental temperature.

3. The charging control method of claim 1, wherein a state of charge, before charging, of the battery to be charged is designated a second state of charge, and the first state of charge is set in a range to which the battery at the second state of charge can be charged within a predetermined time until the subsequent travel.

4. The charging control method of claim 3, wherein the first state of charge is determined so that a state of charge of the battery after discharging a predicted discharge amount of electricity from the first state of charge is higher than a third state of charge that is a lowest allowable state of charge for the battery, the predicted discharge amount being predicted to be discharged by travel over the predetermined route.

5. The charging control method of claim 4, wherein the predicted discharge amount is set taking into consideration a length of a route to be traveled by the vehicle.

6. The charging control method of claim 4, wherein the predicted discharge amount is set taking into consideration a meteorological condition of a route to be traveled by the vehicle.

7. The charging control method of claim 4, wherein the predicted discharge amount is set taking into consideration congestion of a route traveled by the vehicle.

8. The charging control method of claim 4, wherein the vehicle is a vehicle for passenger transportation, and the predicted discharge amount is set taking into consideration an estimated number of users on board the vehicle.

9. The charging control method of claim 4, further comprising changing the operation schedule when the first state of charge of the battery cannot be set to a state of charge reachable within the predetermined time so that the state of charge of the battery after discharge of the predicted discharge amount is higher than the third state of charge.

10. The charging control method of claim 1, wherein the first state of charge is determined by a controller of the vehicle.

11. A server for controlling charging of a battery of each vehicle in a plurality of vehicles, each vehicle traveling along a predetermined route in accordance with an operation schedule and then sequentially switching with another vehicle and charging the battery for subsequent travel, the server comprising:
an acquisition interface configured to acquire an environmental temperature at which charging is to be performed;
a controller configured to determine a first state of charge, at which charging is to end, based on the environmental temperature; and
a communication interface configured to transmit, to a charging apparatus, an instruction to charge the battery of the vehicle to be charged to the first state of charge; wherein
the controller is configured to determine the first state of charge when the environmental temperature is a second temperature lower than a first temperature to be lower than the first state of charge when the environmental temperature is the first temperature.

12. The server of claim 11, wherein the controller is configured to determine the first state of charge as a function of the environmental temperature.

13. The server of claim 11, wherein a state of charge, before charging, of the battery to be charged is designated a second state of charge, and the controller is configured to set the first state of charge in a range to which the battery at the second state of charge can be charged within a predetermined time until the subsequent travel.

14. The server of claim 13, wherein the controller is configured to determine the first state of charge so that a state of charge of the battery after discharging a predicted discharge amount of electricity from the first state of charge is higher than a third state of charge that is a lowest allowable state of charge for the battery, the predicted discharge amount being predicted to be discharged by travel over the predetermined route.

15. The server of claim 14, wherein the controller is configured to change the operation schedule when the first state of charge of the battery cannot be set to a state of charge reachable within the predetermined time so that the state of charge of the battery after discharge of the predicted discharge amount is higher than the third state of charge.

16. A system for controlling charging of a battery of each vehicle in a plurality of vehicles, each vehicle traveling along a predetermined route in accordance with an operation schedule and then sequentially switching with another vehicle and charging the battery for subsequent travel, the system comprising:
the plurality of vehicles;
a temperature sensor configured to measure an environmental temperature at which charging is to be performed;
a server comprising a controller configured to determine a first state of charge, at which charging is to end, based on the environmental temperature; and
a charging apparatus configured to charge the battery of the vehicle to be charged to the first state of charge; wherein
the controller is configured to determine the first state of charge when the environmental temperature is a second temperature lower than a first temperature to be lower than the first state of charge when the environmental temperature is the first temperature.

17. The system of claim 16, wherein the controller is configured to determine the first state of charge as a function of the environmental temperature.

18. The system of claim 16, wherein a state of charge, before charging, of the battery to be charged is designated a second state of charge, and the controller is configured to set the first state of charge in a range to which the battery at the second state of charge can be charged within a predetermined time until the subsequent travel.

19. The system of claim 18, wherein the controller is configured to determine the first state of charge so that a state of charge of the battery after discharging a predicted discharge amount of electricity from the first state of charge is higher than a third state of charge that is a lowest allowable state of charge for the battery, the predicted discharge amount being predicted to be discharged by travel over the predetermined route.

20. The system of claim 19, wherein the controller is configured to change the operation schedule when the first state of charge of the battery cannot be set to a state of charge reachable within the predetermined time so that the state of charge of the battery after discharge of the predicted discharge amount is higher than the third state of charge.
